(19) United States
(12) Patent Application Publication
(10) Pub. No.: US 2025/0065273 A1
(43) Pub. Date: Feb. 27, 2025

(54) DIAGNOSIS METHOD FOR SEPARATION MEMBRANE MODULE AND DETERIORATION DIAGNOSIS DEVICE FOR SEPARATION MEMBRANE MODULE

(71) Applicant: Toray industries, Inc., Chuo-ku, Tokyo (JP)

(72) Inventors: Masahide TANIGUCHI, Otsu-shi, Shiga (JP); Kazunori TOMIOKA, Otsu-shi, Shiga (JP); Koji NAKATSUJI, Iyo-gun, Ehime (JP); Takao UETE, Iyo-gun, Ehime (JP); Seiichi AMAMIYA, Otsu-shi, Shiga (JP); Tomohiro MAEDA, Iyo-gun, Ehime (JP); Shinya SHIMODA, Iyo-gun, Ehime (JP)

(73) Assignee: Toray industries, Inc., Chuo-ku, Tokyo (JP)

(21) Appl. No.: 18/724,401

(22) PCT Filed: Dec. 26, 2022
(86) PCT No.: PCT/JP2022/047956

§ 371 Date: Jun. 26, 2024

(30) Foreign Application Priority Data
Dec. 27, 2021 (JP) 2021-213457

(51) Int. Cl. B01D 65/10; B01D 61/02; B01D 63/10; G01N 13/04

(52) U.S. Cl. CPC B01D 65/10; B01D 61/025; B01D 63/10; G01N 13/04

(57) ABSTRACT

The present invention relates to a state diagnosis method for a separation membrane module for obtaining permeate water from water-to-be-treated, the state diagnosis method including: supplying a test water containing at least two types of solutes to a separation membrane module, or individually supplying at least two types of a test water containing at least one type of solute to the separation membrane module; and comparing a separation performance based on a concentration of the solute contained in the permeate water to determine any of a type of an abnormality, a degree of an abnormality, and a generation position of an abnormality of the separation membrane module.

### CROSS REFERENCE TO RELATED APPLICATIONS

This application is the U.S. National Phase of PCT/JP2022/047956, filed Dec. 26, 2022, which claims priority to Japanese Patent Application No. 2021-213457, filed Dec. 27, 2021, the disclosures of these applications being incorporated herein by reference in their entireties for all purposes.

### FIELD OF THE INVENTION

The present invention relates to a diagnosis method for a separation membrane module

and a deterioration diagnosis device for a separation membrane module.

### BACKGROUND OF THE INVENTION

In recent years, depletion of water resources has become serious, and use of water resources that have not been used so far has been studied. In addition, as a new technique for this purpose, a separation membrane having very high separation efficiency compared to sand filtration, an evaporation method, and the like of the related art, such as a microfiltration membrane, an ultrafiltration membrane, a nanofiltration membrane, a reverse osmosis membrane, and an ion exchange membrane, has been applied to water treatment. Separation membranes, in particular, reverse osmosis membranes have been attracting great attention to techniques for, in particular, producing drinking water or the like from seawater that is most familiar to us and has not been able to be used as it is, so-called seawater desalination, and further, to reuse techniques for purifying wastewater and regenerating treated water.

In the related art, seawater desalination has been put into practical use mainly in an evaporation method in the Middle East region in which there are extremely few water resources and there are very large amounts of heat resources derived from petroleum. Recently, technical advances in the reverse osmosis membrane method have improvement in reliability and cost reduction, and a reverse osmosis membrane method seawater desalination plant has been put into practical use in the Middle East region.

The reverse osmosis membrane method is also applied to wastewater reuse in an urban area and an industrial area located in internal land or along a sea, an area where there is no water source, an area where the amount of discharge is restricted due to drainage regulation, and the like. In particular, Singapore is responding to water shortages by treating domestic sewage generated in the country and then using reverse osmosis membranes to regenerate it to drinking-quality water.

The reverse osmosis membrane method applied to the seawater desalination or wastewater reuse under use is a water production method in which a pressure equal to or higher than an osmotic pressure is applied to water containing a solute such as salt to allow the water to permeate through a reverse osmosis membrane, thereby obtaining desalted water. When this technique is used, drinking water can be obtained from, for example, seawater or brine, and it has also been used for production of industrial ultrapure water, drainage treatment, recovery of valuable materials, and the like.

However, during a normal operation in various water treatment plants, the reverse osmosis membrane may be exposed to a high pressure for a long period of time, or a sterilizer used for sterilization of raw water taken in, a flocculant used in pretreatment, and other residues may come into contact with a reverse osmosis membrane surface, and chemical deterioration may occur in the reverse osmosis membrane due to chemical cleaning with a strong acid, a strong alkali, or the like generally performed when the reverse osmosis membrane is contaminated. In addition, even when the pretreatment according to the raw water quality is applied, the membrane surface of the reverse osmosis membrane may be physically damaged due to the remaining foreign matter in water-to-be-treated and scale or foulant generated during the operation coming into contact with the membrane surface of the reverse osmosis membrane, when a reverse osmosis membrane element module is used, wrinkles generated on the membrane surface due to a sudden change in an operation condition come into strong contact with a channel member to form a physical damage portion, or the channel member comes into strong contact with the membrane surface to form a physical damage portion. Therefore, by periodically examining a performance of the reverse osmosis membrane, when the chemical deterioration or physical damage occurs, it is necessary to take a measure against the cause of damage.

As a method for examining whether there is physical damage to a reverse osmosis membrane, there is known a method in which a dye solution (a solution of Basic Violet 1 (manufactured by Tokyo Chemical Industry Co., Ltd.)) is cross-flowed on a skin layer side having a reverse osmosis function of a membrane piece taken out by disassembling a reverse osmosis membrane element to be examined at a linear velocity of 0.1 cm/sec to 0.2 cm/sec and passed through the membrane piece under an operating pressure of 1.5 MPa for 30 minutes or more, and then visually observing is performed to determine whether an evaluation membrane had a dyed region (Patent Literature 1).

As a method for examining whether there is chemical deterioration in a reverse osmosis membrane, there is known a method in which a reverse osmosis membrane element to be examined is disassembled, the reverse osmosis membrane is taken out, and then the membrane piece is immersed in a solution in which an alkali aqueous solution and pyridine are mixed, and chemical deterioration, particularly oxidative deterioration is identified by the presence or absence of color in the solution (Non-Patent Literature 1).

On the other hand, even in a case of a membrane other than the reverse osmosis membrane, chemical deterioration and physical deterioration often becomes a problem. For example, when an oxidizing substance is contained in water-to-be-treated, for example, in ground water or industrial wastewater, a separation membrane made of an organic polymer is subjected to accelerated oxidation by the oxidizing substance and causes chemical deterioration. When the water-to-be-treated contains a substance with high hardness, the separation membrane is physically damaged or scratched. Regarding this deterioration, it is known that a pressure decay test (PDT) (Non-Patent Literature 2) or air leak test is for detecting large physical damage, a bubble point test (Non-Patent Literature 3) or a molecular weight cutoff test (Non-Patent Literature 4) which is at a laboratory level is used as a test for checking a separation performance decrease due to chemical deterioration or the like.

### PATENT LITERATURE

Patent Literature 1: WO2015/063975

Patent Literature 2: WO2020/071507

### NON-PATENT LITERATURE

Non-Patent Literature 1: R. Sandin et al./Desalination and Water Treatment 51 (2013) 318-327 “Reverse osmosis membranes oxidation by hypochlorite and chlorine dioxide: spectroscopic techniques vs. Fujiwara test”

Non-Patent Literature 2: United States Environmental Agency/MEMBRANE FILTRATION GUIDANCE MANUAL (2005), p 183

Non-Patent Literature 3: Japan Industrial Standard, JIS K3832-1990, Bubble Point Test Method for Microfiltration Membrane Element and Module

Non-Patent Literature 4: Haruhiko Oya et al., Membrane, Vol. 16, No. 1, 1991, p 34

Non-Patent Literature 5: Journal of Membrane Science, Volume 183, 2000, p 259-267

Non-Patent Literature 6: Journal of Membrane Science, Volume 183, 2000, p 249-258

### SUMMARY OF THE INVENTION

However, according to the study of the present inventors, in the method of the related art, it is necessary to disassemble the separation membrane module and take out and analyze the membrane piece in order to diagnose the cause of the performance deterioration of the separation membrane module used in various water treatment plants, resulting in a problem that diagnosing the cause of a trouble takes time and delays countermeasures.

The present invention has been made in view of the above circumstances of the related art, and an object of the present invention is to provide a diagnosis method for a separation membrane module and a deterioration diagnosis device for a separation membrane module, which can extremely simply and quickly diagnose the cause of performance deterioration of the separation membrane module.

In order to solve the above problems, the present invention has the following configurations.

(1) A state diagnosis method for a separation membrane module for obtaining permeate water from water-to-be-treated, the state diagnosis method including:

supplying a test water containing at least two types of solutes to a separation membrane module, or individually supplying at least two types of a test water containing at least one type of solute to the separation membrane module; and

comparing a separation performance based on a concentration of the solute contained in the permeate water to determine any of a type of an abnormality, a degree of an abnormality, and a generation position of an abnormality of the separation membrane module.

(2) The state diagnosis method for a separation membrane module according to the above (1), in which

the at least two types of solutes are ionic substances having different valences or substances having different molecular weights.

(3) The state diagnosis method for a separation membrane module according to the above (1) or (2), in which

the comparison of the separation performance is performed based on a concentration index of the permeate water, a concentration converted from the concentration index, a standard separation performance converted based on an operation condition, and a solute permeability coefficient calculated based on an operation data.

(4) The state diagnosis method for a separation membrane module according to the above (2) or (3), in which

the ionic substances having different valences are at least a substance including a monovalent cation and a substance including a divalent cation.

(5) The state diagnosis method for a separation membrane module according to any of the above (2) to (4), in which

the ionic substances having different valences are at least a substance including a monovalent anion and a substance including a divalent anion.

(6) The state diagnosis method for a separation membrane module according to the above (1), in which

the at least two types of the test water have a same solute and is changed in pH or temperature.

(7) The diagnosis method for a separation membrane module according to the above (3), in which

the concentration index of the permeate water is any of an electrical conductivity, TOC, a refractive index, a turbidity, an absorbance, an emission intensity, a chromaticity, IR, a mass spectrometry, an ion chromatography, ICP, pH, and a radiation ray.

(8) The state diagnosis method for a separation membrane module according to any of the above (1) to (7), in which

the permeate water is taken in from at least two positions of a module, and the separation performances are compared.

(9) The state diagnosis method for a separation membrane module according to the above (8), in which

a method of taking in the permeate water from the at least two positions is a method of passing a thin tube to the separation membrane module and collecting the permeate water at different positions of the separation membrane module to measure a water quality.

(10) The state diagnosis method for a separation membrane module according to the above (9), in which

the separation membrane module is a spiral-type reverse osmosis membrane module, and taking in the permeate water is performed by inserting the tube into a central pipe for permeate water collection and moving the tube.

(11) The state diagnosis method for a separation membrane module according to any of the above (8) to (10), in which

the separation membrane module has a structure that allows the permeate water to be taken in from at least two positions, and a flow rate ratio of the permeate water is changed.

(12) The state determination method for a separation membrane module according to any of the above (1) to (11), in which

the separation performance for the test water in a state before use of the separation membrane module is measured or predicted in advance, and a state of the separation membrane module is determined based on a deviation from a value thereof.

(13) The state determination method for a separation membrane module according to the above (12), in which

a chemical deterioration profile in which the separation performance deteriorates by bringing the separation membrane module into contact with a chemical and a physical deterioration profile in which the separation performance decreases by causing a physical scratch on a supply side of the separation membrane module are prepared in advance, and contribution of a chemical deterioration and a physical deterioration is determined by comparing the prepared profiles with a measured separation performance of the separation membrane module.

(14) The state determination method for a separation membrane module according to the above (1), in which

in the comparison of the separation performance of the at least two types of solutes, when a separation performance decrease rate of the solute having a higher separation performance is twice or more as large as a separation performance decrease rate of the solute having a lower separation performance, it is determined that the physical deterioration occurs.

(15) A state diagnosis device for a separation membrane module, the state diagnostic device including:

at least two types of detectors configured to supply a test water containing at least two types of solutes to a separation membrane module and periodically detect a concentration of each of the solutes contained in permeate water;

a separation performance comparing unit configured to compare separation performances based thereon; and

an abnormality determining unit configured to automatically determine any of a type of an abnormality, a degree of an abnormality, and a generation position of an abnormality of the separation membrane module by the separation performance comparing unit.

(16) The state diagnosis device for a separation membrane module according to the above (15), in which

the detector is an online detector in which any of an electrical conductivity, a UV absorption, TOC, a refractive index, a turbidity, an absorbance, a fluorescence intensity, a chromaticity, and pH is detected, and

the state diagnosis device includes a calculation unit configured to automatically calculate a degree of performance decrease of the separation membrane module and a contribution rate of a physical deterioration and a contribution rate of a chemical deterioration based on any of a concentration index automatically based on a detection value, a concentration converted from the concentration index, a standard separation performance converted based on an operation condition, and a solute permeability coefficient calculated based on an operation data.

(17) The state diagnosis device for a separation membrane module according to the above (15) or (16), in which

the separation performance of the separation membrane module obtained by adding the two types of solutes to water-to-be-treated in a pulsed manner and measuring a change in permeate water quality is compared and automatically make determination.

(18) The calculation unit for state diagnosis of the separation membrane module according to any of the above (15) to (17) and a computer-readable recording medium recording the calculation unit.

When the diagnosis method for a separation membrane module and the deterioration diagnosis device for a separation membrane module according to the present invention are used, the cause of performance deterioration of the separation membrane module can be diagnosed extremely easily and quickly. As a result, it is possible to stably operate the separation membrane in the water treatment plant and to stably and inexpensively obtain fresh water and clear water by urgently taking a countermeasure of the water treatment plant based on a diagnosis result.

### BRIEF DESCRIPTION OF DRAWINGS

FIG. 1 is a partially exploded perspective view of a most typical spiral-type reverse osmosis membrane element.

FIG. 2 is a side sectional view of a reverse osmosis membrane module in which a spiral-type reverse osmosis membrane element is stored in a pressure resistant container.

FIG. 3 is a side sectional view of a general hollow fiber microfiltration membrane module.

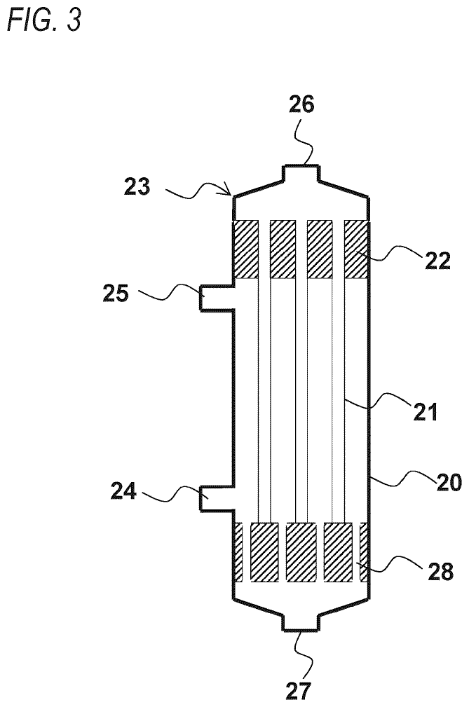

FIG. 4 is a schematic view showing a method of measuring local permeate water quality through a tube from a permeate water pipe of the reverse osmosis membrane module.

FIG. 5 is a schematic diagram of a reverse osmosis membrane element performance evaluation device including a separation membrane module having two or more permeate water intake ports.

FIG. 6 is a graph showing a change in separation performance and contribution rates of chemical deterioration and physical deterioration in Example 1.

FIG. 7 is a graph showing a distribution of each ionic substance concentration in permeate water in a length direction of a water collection pipe in Example 2.

FIG. 8 is a graph showing a separation performance change rate in the length direction of the water collection pipe and contribution rates of chemical deterioration and physical deterioration in the length direction of the water collection pipe in Example 2.

FIG. 9 is a graph showing a change in separation performance and contribution rates of chemical deterioration and physical deterioration in Example 3.

FIG. 10 is a graph showing a distribution of each ionic substance concentration in permeate water in a length direction of a water collection pipe in Example 4.

FIG. 11 is a graph showing a separation performance change rate in the length direction of the water collection pipe and contribution rates of chemical deterioration and physical deterioration in the length direction of the water collection pipe in Example 4.

FIG. 12 is a graph showing a change in separation performance and contribution rates of chemical deterioration and physical deterioration in Example 5.

FIG. 13 is a graph showing a distribution of each ionic substance concentration in permeate water in a length direction of a water collection pipe in Example 6.

FIG. 14 is a graph showing a separation performance change rate in the length direction of the water collection pipe and contribution rates of chemical deterioration and physical deterioration in the length direction of the water collection pipe in Example 6.

FIG. 15 is a graph showing a change in separation performance and contribution rates of chemical deterioration and physical deterioration in Example 7.

FIG. 16 is a graph showing a distribution of each ionic substance concentration in permeate water in a length direction of a water collection pipe in Example 8.

FIG. 17 is a graph showing a separation performance change rate in the length direction of the water collection pipe and contribution rates of chemical deterioration and physical deterioration in the length direction of the water collection pipe in Example 8.

### DETAILED DESCRIPTION OF EMBODIMENTS OF THE INVENTION

Hereinafter, the present invention will be described in detail, but an example of a preferred embodiment the present invention is described and the present invention is not limited thereto. Note that when simply described as the present invention, it means a concept including a first embodiment, a second embodiment, and a third embodiment to be described later.

### [Diagnosis Method for Separation Membrane Module]

A diagnosis method according to a first embodiment of the present invention (hereinafter, may be simply referred to as the first embodiment) is a state diagnosis method for a separation membrane module characterized in that test water containing two types of solutes is supplied to the separation membrane module, concentrations of the two types of solutes contained in permeate water are measured, and separation performances obtained based on the measurement are compared to determine any one of a type of an abnormality, a degree of an abnormality, and a generation position of an abnormality of the separation membrane module. Specifically, the separation performance (generally represented by a removal rate) of each of the first solute and the second solute has a certain ratio based on the characteristics of the separation membrane. For example, in a case of a reverse osmosis membrane module, it is stated that a NaCl removal rate is 99.6% and a boron removal rate is 90% as exemplified in the literature “Toray TSW-LE Series Catalog”. Major factors that cause the separation performance decrease in the separation membrane module are chemical deterioration and physical deterioration as described above, and a relationship of the deterioration of the separation performance is different depending on the respective factors. Examples of the chemical deterioration in this case include chemical deterioration when a separation functional layer of the reverse osmosis membrane comes into contact with a chemical and starts to deteriorate.

The chemical deterioration in the present invention is, for example, a change in molecular chain arrangement of polymer components of the separation functional layer, cleavage, or loss of low molecular weight polymers, and a form of the chemical deterioration is not particularly limited.

In a plant using a reverse osmosis membrane element, an oxidizing agent is often used in pretreatment of raw water supplied to the reverse osmosis membrane element, and it is known that a part of the oxidizing agent leaks into the reverse osmosis membrane element to cause oxidative deterioration. In the present invention, the oxidizing agent is not particularly limited, but the main cause of chemical deterioration is often an oxidative deterioration that is caused by hypochlorous acid used for sterilization of raw water or hypobromous acid generated by conversion from hypochlorous acid.

In the case of chemical deterioration, a removal performance of the two types of solutes decreases with a certain relationship. Specifically, for example, as shown in Non-Patent Literature 5 (Journal of Membrane Science, Volume 183, 2000, p 259-267), it has been found that there is a constant relationship, nearly proportional relationship, between a decrease in a NaCl removal performance and decrease in a boron removal performance. As a result of intensive studies by the inventors of the present application, it was confirmed that this relationship is the same for other solutes. That is, a change in the removal performance of the two types of solutes have a certain relationship (in most cases, the performance often decreases in a linear relationship from a performance of new product to a certain level). That is, the separation performance of the test water in the state before use of the separation membrane module is measured or predicted in advance, and the state of the separation membrane module is determined based on a deviation from the value thereof, whereby the abnormality can be detected and diagnosed.

A phenomenon is observed in which when the chemical deterioration starts to occur in the reverse osmosis membrane, a permeation amount of monovalent ionic substance becomes larger prior to a permeation amount of divalent ionic substance, and when the chemical deterioration progresses further, the permeation amount of the divalent ionic substance also increases, and the difference from the permeation amount of the monovalent ionic substance is reduced. Accordingly, an initial state (minor deterioration) of chemical deterioration due to chemical contact can be diagnosed from a degree of separation performance decrease between the monovalent ionic substance and the divalent ionic substance.

In a simple manner, for example, in the case of diagnosing the reverse osmosis membrane using the monovalent ionic substance and the divalent ionic substance, when a concentration of the monovalent ionic substance is 0.9% by mass or more of a concentration of the monovalent ionic substance in the raw water, and a concentration of the divalent ionic substance in permeate water in a water collection pipe is 0.2% by mass or less of the concentration of the divalent ionic substance in the raw water, it can be diagnosed that the main cause of deterioration of the reverse osmosis membrane element is chemical deterioration.

On the other hand, in a case of physical deterioration, although it is possible to obtain a relationship expression by measuring characteristics of the separation membrane module having no leakage and the separation membrane module having caused the leakage, basically, there is a phenomenon in which supply water (test water or water-to-be-treated) leaks, that is, a permeate water concentration deteriorates depending on a composition of the supply water, regardless of the separation performance of the membrane, due to scratches or large holes in the membrane, adhesive portions, other gaps, and the like, and therefore the physical deterioration can be approximately determined by calculation. For example, in a case where an Na ion concentration of the supply water is 32000 mg/L and the boron concentration is 5 mg/L, in a normal new separation membrane module, for example, the permeate water concentrations are 100 mg/L and 0.5 mg/L respectively, and when chemical deterioration occurs, the performance decreases to, for example, 150 mg/L and 0.75 mg/L, respectively, and in a case where physical deterioration occurs, for example, when 0.1% of supply water leaks in, the permeate water concentration becomes 132 mg/L and 0.505 mg/L, and the separation performance of Na ion decreases significantly. In such a case, it can be determined that physical deterioration has occurred.

In a simple manner, when a separation performance decrease rate A (a magnification of a permeability) of a solute having a lower separation performance and a separation performance decrease rate B of a solute having a higher separation performance is significantly larger than a separation performance decrease rate A of a solute having a lower separation performance, it can be determined that physical deterioration occurs at least. Specifically, if A>B×2, it may be determined that physical deterioration has occurred.

As a specific example, it is obtained by the following formula (1).

Change rate of divalent ionic substance>change rate of monovalent ionic substance (1)

However, the change rate of the monovalent ionic substance is a value obtained by the following formula (2), and the change rate of the divalent ionic substance is a value obtained by the following formula (3).

Change rate of monovalent ionic substance=(maximum concentration of monovalent ionic substance in permeate water at a plurality of positions in water collection pipe)/(minimum concentration of monovalent ionic substance in permeate water at a plurality of positions in water collection pipe) (2)

Change rate of divalent ionic substance=(maximum concentration of divalent ionic substance in permeate water at a plurality of positions in water collection pipe)/(minimum concentration of divalent ionic substance in permeate water at a plurality of positions in water collection pipe) (3)

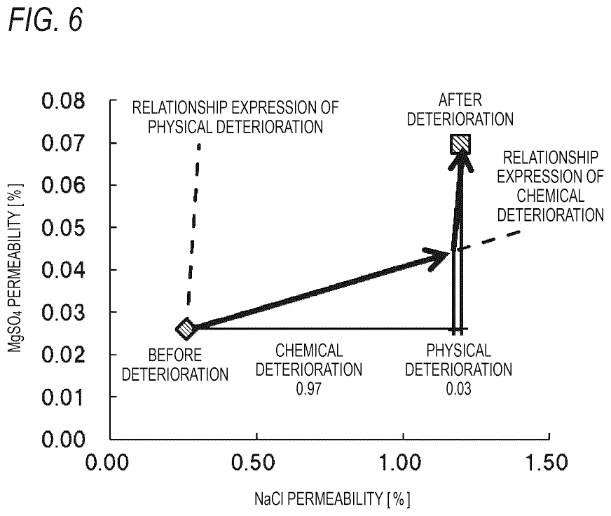

As shown in FIG. 6 (picture of vectors of chemical deterioration and physical deterioration), a relationship profile of chemical deterioration due to chemical contact and physical deterioration due to scratches is created and acquired in advance, and compared with the measured separation performance of the separation membrane module, contribution of the chemical deterioration and the physical deterioration can be determined by decomposing into two arrows of a relationship between the change rates of the monovalent ion and the divalent ion in the case of the chemical deterioration and a relationship between the change rates of the monovalent ion and the divalent ion of the physical deterioration.

In the first embodiment, the test water in which the two types of ions having different valences are mixed is used, but it is also possible to prepare two types of test water containing only one type of different solutes, supply the test water to the separation membrane module individually, take the permeate water, and diagnose the separation membrane module after obtaining two types of separation performances.

Hereinafter, a second embodiment of the present invention (hereinafter, may be simply referred to as the second embodiment) will be described. There is provided a diagnosis method for a reverse osmosis membrane element according to the second embodiment in which first water-to-be-treated containing a monovalent ionic substance is pressurized and supplied to a reverse osmosis membrane element having a water collection pipe at a pressure equal to or higher than an osmotic pressure of the first water-to-be-treated, the first water-to-be-treated is separated into first concentrated water and first permeate water, and then the first permeate water is collected at a plurality of positions in the water collection pipe, and before or after the first permeate water is collected, second water-to-be-treated containing a divalent ionic substance is pressurized and supplied to the reverse osmosis membrane element at a pressure equal to or higher than an osmotic pressure of the second water-to-be-treated, the second water-to-be-treated is separated into second concentrated water and second permeate water, and then the second permeate water is collected at a plurality of positions in the water collection pipe, and the concentration of the monovalent ionic substance in the first permeate water is obtained by measuring water quality of the first permeate water, and the concentration of the divalent ionic substance in the second permeate water is obtained by measuring water quality of the second permeate water to diagnose a deterioration state of the reverse osmosis membrane element from a change in the concentration of the monovalent ionic substance and a change in the concentration of the divalent ionic substance.

The concentration of the monovalent ionic substance in the first water-to-be-treated is preferably 50 mg/L to 70000 mg/L, and more preferably 500 mg/L to 35000 mg/L. The concentration of the divalent ionic substance in the second water-to-be-treated is preferably 50 mg/L to 10000 mg/L, and more preferably 50 mg/L to 4000 mg/L.

The first treated water can be obtained, for example, by blending a monovalent ionic substance with pure water. The second treated water can be obtained, for example, by blending a divalent ionic substance with pure water.

The reverse osmosis membrane element is as described above.

The pressure when the mixed water-to-be-treated is pressurized and supplied to the reverse osmosis membrane element is preferably 0.5 MPa to 10 MPa, more preferably 0.75 MPa to 6 MPa.

A first water-to-be-treated flow rate when separating the first water-to-be-treated into the first concentrated water and the first permeate water is, for example, preferably 50 L/min to 1000 L/min, and more preferably 120 L/min to 500 L/min in a case of a reverse osmosis membrane element having a size of an outer diameter of about 201 mm (about 8 inches). A temperature of the first water-to-be-treated at that time is preferably 5° C. to 45° C., and more preferably 20° C. to 35° C. The pH of the first water-to-be-treated at that time is preferably 2 to 11, and more preferably 6 to 8.5.

A second water-to-be-treated flow rate when the second water-to-be-treated is separated into the second concentrated water and the second permeate water is, for example, preferably 50 L/min to 1000 L/min, and more preferably 120 L/min to 500 L/min in the case of the reverse osmosis membrane element having a size of an outer diameter of about 201 mm (about 8 inches). A temperature of the second water-to-be-treated at that time is preferably 5° C. to 45° C., and more preferably 20° C. to 35° C. The pH of the second water-to-be-treated at that time is preferably 2 to 11, and more preferably 6 to 8.5.

The concentration of the monovalent ionic substance in the first permeate water is determined by measuring the water quality of the first permeate water. The concentration of the divalent ionic substance in the second permeate water is obtained by measuring the water quality of the second permeate water.

Specific examples of the water quality of the first permeate water and the second permeate water include a conductivity, ion concentrations, and total dissolved solid concentration of the first permeate water and the second permeate water.

The concentration of the monovalent ionic substance is preferably a value obtained from an electrical conductivity of the first permeate water, and the concentration of the divalent ionic substance is preferably a value obtained from an electrical conductivity of the second permeate water. By obtaining the concentration of each ionic substance from the electrical conductivity of each permeate water, measurement such as ion chromatography or titration can be omitted.

In the second embodiment, an order in which the first water-to-be-treated and the second water-to-be-treated are pressurized and supplied is not limited, and either of them may be pressurized and supplied first. For example, when the first water-to-be-treated is pressurized and supplied first, before the second water-to-be-treated is pressurized and supplied, the first water-to-be-treated may be changed to water such as pure water and supplied to the reverse osmosis membrane element to wash out the first water-to-be-treated.

In the first embodiment described above, Na (monovalent strong cationic substance) and boron (trivalent weak anionic substance) are used. It is preferable to use ionic substances with different valences, it is also preferable to use substances with different molecular weights. Further, in actual application, it is preferable to use a component which has a large difference in removal performance and is easy to measure. Since a surface of the separation membrane is often charged, it is also preferable that the two types of ions are the same type of ions having different valences. That is, for example, a monovalent cation and a divalent cation, or a monovalent anion and a divalent anion are used.

The monovalent ionic substance used in the present invention is not particularly limited, but is preferably completely dissociated and neutral when dissolved in water such as pure water, for example, Na and Mg, and Cl and SO₄ are particularly preferable because they are naturally present in a large number, are easy to handle and relatively inexpensive. Further, in a separation membrane for water treatment for treating natural water such as seawater or river water, the membrane surface is often negatively charged as natural organic substance generally has a weak anion. In that case, it is preferable to use cations such as Na and Mg. In particular, sodium chloride is preferably used as the monovalent ionic substance. In addition, the divalent ionic substance used in the present invention is not particularly limited as long as it is completely dissociated and neutral when dissolved in water such as pure water, and magnesium sulfate is preferably used for the same reason. When these are simultaneously selected, the cation and the anion have different characteristics, which is very preferable.

The concentration in the test water is preferably set to conditions that make it easy to measure, but is not particularly limited. Generally, the concentration of the monovalent ionic substance is preferably 50 mg/L to 70000 mg/L, more preferably 500 mg/L to 35000 mg/L, and the concentration of the divalent ionic substance is preferably 50 mg/L to 10000 mg/L, more preferably 500 mg/L to 4000 mg/L.

Although the “at least two types of test water” in the present invention are basically different in solutes, it is also possible to change the pH or temperature of the same solute to make it substantially different solutes. For example, when the pH of the solute containing carbonate is changed, the solute is dissociated, that is, the valence thereof changes, resulting in a solute with different characteristics. This is an applicable method because the characteristics of the solute, in particular, a polymeric solute change by changing the temperature thereof. When the pH or the temperature is changed, the membrane performance may also change, and the chemical change can be easily determined. (In the case of physical deterioration, a change in membrane performance basically does not influence.) However, it should be noted that changing the pH or the temperature requires chemicals, thermal energy, and time and effort for these.

It is preferable for the test water to contain only the components intended for measurement, as this will increase the analysis accuracy, but in this case, when it is desired to diagnose a separation membrane module used for use (during an operation), it is necessary to stop the supply of the water-to-be-treated and switch to the test water or to remove the separation membrane module from the equipment and load it into a device for diagnosis. When it is desired to perform the diagnosis during an actual operation of the plant, it is also possible to use the water-to-be-treated as the test water in the state during an operation. However, it should be noted that a solute other than the solute to be subjected to comparative evaluation is often contained, which affects the analysis accuracy. If there is a difficulty in the concentration analysis accuracy of the water-to-be-treated or the permeate water during an operation, one of preferable methods is to increase sensitivity by adding two types of solutes to be compared and evaluated to the water-to-be-treated in a pulsed manner.

Here, the separation performance of the membrane module generally includes a removal rate (=1−the permeate water concentration/the supply water concentration), a permeability (=the permeate water concentration/the supply water concentration), a permeability coefficient, and the like.

Regarding the permeability coefficient, simply, for example, as represented by a unit of kg/m²/Pa/s, the permeation amount per membrane area, per pressure, per time can be calculated, but more strictly, the permeability coefficient can be calculated by a calculation method in consideration of an osmotic pressure and a concentration polarization described in Non-Patent Literature 6 “Journal of Membrane Science, Volume 183, 2000, p 249-258” and further in consideration of a change in temperature of the membrane performance.

$$Specifically , {J}_{v} = {L}_{p} ( Δ P - Δπ )$$

$${J}_{s} = P ( {C}_{m} - {C}_{p} )$$

$$Δπ = π ( {C}_{m} ) - π ( {C}_{p} )$$

$$( {C}_{m} - {C}_{p} ) / ( {C}_{f} - {C}_{p} ) = exp ( {J}_{v} / k )$$

$${J}_{v} : pure water permeation flux [ {m}^{3} / {m}^{2} \cdot s ]$$

$${J}_{s} : solute permeation flux [ kg / {m}^{2} \cdot s ]$$

$${L}_{p} : pure water permeability coefficient [ {m}^{3} / {m}^{2} \cdot Pa \cdot s ]$$

$$P : TDS permeability coefficient [ m / s ]$$

$$π : osmotic pressure [ Pa ]$$

$$Δπ : osmotic pressure difference [ Pa ]$$

$$Δ P : operation pressure difference [ Pa ]$$

$${C}_{m} : supply water membrane surface concentration [ kg / {m}^{3} ]$$

$${C}_{f} : supply bulk concentration [ kg / {m}^{3} ]$$

$${C}_{P} : permeate water concentration [ kg / {m}^{3} ]$$

$$k : solute substance transfer coefficient [ m / s ]$$

Here, the solute substance transfer coefficient k is a value determined by a structure of the separation membrane module or an evaluation cell, and can be obtained as a function of a membrane surface flow rate Q [m³/s] or a membrane surface flow rate u [m/s] by an osmotic pressure method or a flow rate change method described in Non-Patent Literature 5 (Journal of Membrane Science, Volume 183, 2000, p 259-267).

In the case of the flat membrane cell disclosed in Reference Literature 2, k=1.63×10⁻³·Q^{0.4053}.

According to the above equation, unknown numbers Lₚ, P, Cₘ can be calculated. In the case of the separation membrane module, they can be obtained as an average value of the entire module, or Lₚ and P can be calculated by fitting while integrating in a length direction of the membrane element, as shown in Reference Literature 1.

The separation membrane module to which the present invention is applied can be used for various separation membranes such as a reverse osmosis membrane, a nanofiltration membrane, an ultrafiltration membrane, a microfiltration membrane, an ion exchange membrane, a gas separation membrane, and a filter cloth, in particular, when the present invention is applied to a microfiltration membrane, an ultrafiltration membrane, a nanofiltration membrane, or a reverse osmosis membrane for water treatment for producing drinking water or various kinds of water for use by treating seawater, river water, or the like, it is possible to contribute to a reduction in water treatment cost, which is very preferable. In addition, a shape of the module is not particularly limited, and may include a spiral type, a hollow fiber type, a flat membrane parallel plate (plate and frame) type, and the like.

As a material of the reverse osmosis membrane or the nanofiltration membrane used in the present invention, for example, a polymeric material such as a cellulose acetate-based polymer, polyamide, polyester, polyimide, or a vinyl polymer can be used. In addition, a structure of the membrane may be either an asymmetric membrane having a dense layer on at least one surface of the membrane and fine pores gradually increasing in diameter from the dense layer toward the inside of the membrane or the other surface, or a composite membrane having a very thin functional layer formed of another material on the dense layer of the asymmetric membrane.

Examples of the ultrafiltration membrane and the microfiltration membrane include porous membranes such as polyacrylonitrile, polyimide, polyether sulfone, polyphenylene sulfide sulfone, polytetrafluoroethylene, polypropylene, and polyethylene.

The present invention can be applied to a composite separation membrane having high permeability by compounding rubber-like polymers such as crosslinked silicone, polybutadiene, polyacrylonitrile butadiene, ethylene-propylene rubber, and neoprene rubber as a functional layer to the porous membrane.

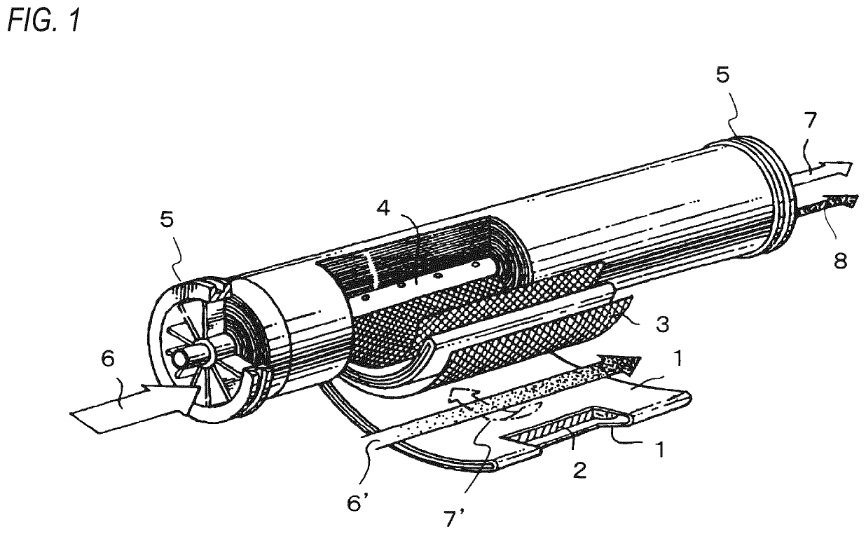

The structure of the separation membrane module varies depending on the application of the membrane, but in the case of reverse osmosis membranes and nanofiltration membranes, spiral type membranes are common. FIG. 1 shows a partially exploded perspective view of an element used as a most typical spiral-type reverse osmosis membrane module.

In a spiral-type reverse osmosis membrane element, generally, a reverse osmosis membrane unit including a reverse osmosis membrane 1, a permeate water channel member 2, and a water-to-be-treated channel member (net spacer) 3 is spirally wound around a water collection pipe 4 having a water collection hole, the outside of the reverse osmosis membrane unit is covered with a film, a glass fiber containing a curable resin, or the like, and a telescope prevention plate 5 is mounted on at least one end portion of the fluid separation element.

As the water-to-be-treated channel member, grid-like channel member which is a net-like or a mesh-like, a grooved sheet, a corrugated sheet, or the like can be used. As the permeate water channel member, grid-like channel member which is a net-like or a mesh-like, a grooved sheet, a corrugated sheet, or the like can be used. Any of them may be a net or sheet independent of the separation membrane, or may be integrated by adhesion or fusion bonding.

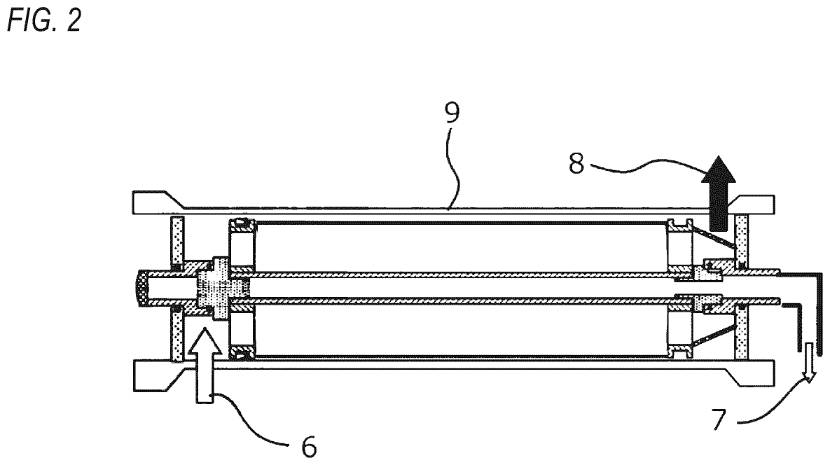

Water-to-be-treated 6 is supplied from the telescope prevention plate 5 to the reverse osmosis membrane through the water-to-be-treated channel member 3, is subjected to a membrane separation treatment, and is separated into permeate water 7 and concentrated water 8, and the permeate water 7 is collected inside the water collection pipe 4 through a hole on the side surface of the water collection pipe 4, passes through the water collection pipe, and is collected from a mouth of the water collection pipe. The spiral-type element can be used by being loaded into a pressure vessel 9 as shown in FIG. 2.

In a case where the reverse osmosis membrane is a flat membrane, the so-called spiral type described above is general, and these elements can be uses by being accommodated in a cylindrical housing (the pressure vessel or the like) and being connected to a pipe of supply water, permeate water, or concentrated water.

The pressure when the mixed water-to-be-treated is pressurized and supplied to the reverse osmosis membrane element is preferably 0.5 MPa to 10 MPa, more preferably 0.75 MPa to 6 MPa.

A mixed water-to-be-treated flow rate when the water-to-be-treated is separated into the mixed concentrated water and the mixed permeate water is, for example, preferably 50 L/min to 1000 L/min, more preferably 120 L/min to 500 L/min in a case of a subject having a size such that a reverse osmosis membrane element has an outer diameter of about 201 mm (about 8 inches). A temperature of the mixed water-to-be-treated at that time is preferably 5° C. to 45° C., more preferably 20° C. to 35° C. The pH of the mixed water-to-be-treated at that time is preferably 2 to 11, more preferably 6 to 8.5.

In the present embodiment, the permeate water may be collected from a right side (a concentrated water outlet side) of the water collection pipe of the pressure vessel 9 as shown in FIG. 2, or may be collected from a left side (a supply water inlet side) of the water collection pipe which is sealed in FIG. 2.

On the other hand, a hollow fiber membrane module to which the present invention is applied generally has a shape in which spaces between the hollow fiber membranes and between the hollow fiber membranes and a module container are airtightly sealed (potting) and opened. As a result, the outside and the inside of the hollow fiber membrane can be isolated by the hollow fiber membrane itself, and separation treatment can be performed through the membrane. As a structure of the hollow fiber membrane module, there is a “both-end opening type” module in which both end portions of the hollow fiber membrane are potted and then opened from both ends, a “one-end opening type” module in which both ends are potted and then only one side is opened, a “U-shape” module in which the hollow fiber membrane is formed into a U-shape and only one side of the hollow fiber membrane is opened, and a “comb type” module in a state in which a U-shaped portion is cut and each hollow fiber membrane is independently sealed. Regarding a filtration direction, there are two cases of flowing the raw water-to-be-treated inside the hollow fiber membrane (internal pressure type) and flowing it outside the hollow fiber membrane (external pressure type), and the present invention can be applied to both cases.

There are no particular limitations on the measurement of the test water and permeate water concentration, and various measurement methods such as an electrical conductivity, TOC, a refractive index, turbidity, absorbance, an emission intensity, chromaticity, IR, mass spectrometry, ion chromatography, ICP, pH, and radiation ray can be used. In the case of using two types of test water composed of one type of solute, it is preferable to use a method capable of easily measuring such as the electrical conductivity in the case of an ionic substance, and the refractive index, the absorbance, the emission intensity, and the like in the case of polymers.

In order to determine each ionic substance concentration from the electrical conductivity of each permeate water, a relationship between each ionic substance concentration and the conductivity may be determined in advance by a known method of the related art. By obtaining the relationship between each ionic substance concentration and the electrical conductivity in advance, the electrical conductivity can be converted into the concentration.

In the case of test water containing two or more types of solutes, it is also preferable to measure multiple components at a time by decomposing residence time and a wavelength by chromatography, absorbance, or the like, scanning, and then detecting and measuring with a detector, and to simultaneously connect two types of different detectors to measure two types of different water quality indexes. In particular, these methods are very preferable when measuring the water quality online in terms of complexity and accuracy of measurement.

In the first embodiment, the separation performance of the entire separation membrane module is measured and diagnosed, but it is also possible to detect a local abnormality in the separation membrane module using the method of the present invention. That is, the permeate water is taken in from at least two positions of the module, and the separation performances are compared with each other, so that it is possible to diagnose a position of an abnormality in the module and type of an abnormality.

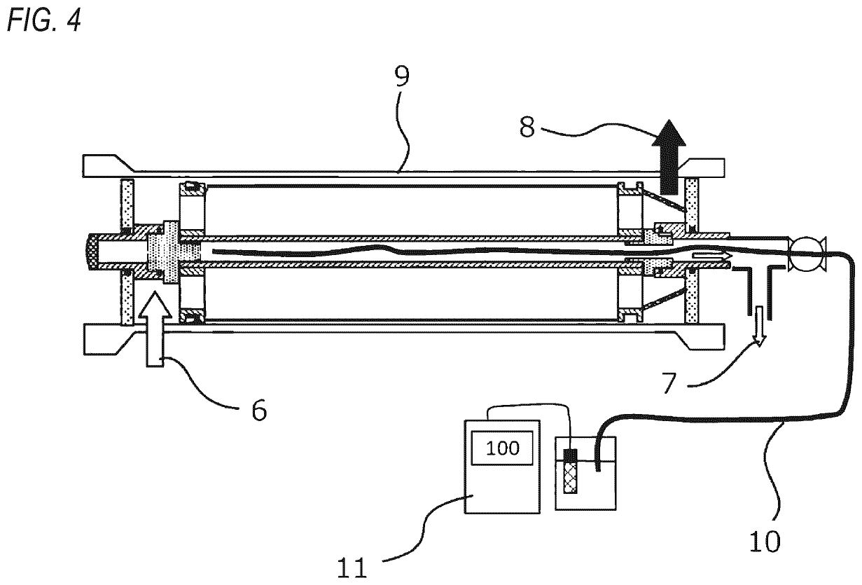

FIG. 4 is a side sectional view showing an example when the spiral-type reverse osmosis membrane module is used as a specific example of the second embodiment. Here, as a method of collecting the mixed permeate water at a plurality of positions in the water collection pipe, acquiring the separation performances of water collection points, and setting the content and points of the abnormality, for example, a method of passing a thin tube through the water collection pipe, holding one end of the tube at a predetermined position of the water collection pipe, and collecting the mixed permeate water at the position from the other end of the tube is exemplified.

At this time, the tube is gradually moved to collect the mixed permeate water at a plurality of positions, the concentration of the monovalent ionic substance and the concentration of the divalent ionic substance in the obtained mixed permeate water are measured by a method such as ion chromatography or titration, and the deterioration state of the separation membrane module can be diagnosed from a change in the concentration of the monovalent ionic substance and the concentration of the divalent ionic substance.

In the case where the tube is used as described above, it is possible to specify where the end of the tube is located within the water collection pipe of the separation membrane module, by marking the length of the tube in advance.

That is, when the electrical conductivity of each permeate water is measured using a tube, the tube may be passed through the water collection pipe, one end of the tube may be held at a predetermined position of the water collection pipe, and the permeate water at the position may be collected from the other end of the tube to measure the electrical conductivity.

Here, when the tube is passed through the permeate water pipe of the pressure vessel, a front end of the tube is held at a predetermined position, and permeate water is collected at a plurality of positions, water is collected at both ends of the water collection pipe on a supply water side and a concentrated water side, and water is collected at substantially equal intervals therebetween. In particular, an interval width is not limited, but in the case of evaluating one reverse osmosis membrane element having an overall length of about 1 m, an interval of about 5 cm is preferable.

As a method of measuring the electrical conductivity of each permeate water, a method of measuring the electrical conductivity by installing a plurality of electrical conductivity sensors at a plurality of positions in the water collection pipe can also be adopted.

The separation membrane module to which the second embodiment can be applied is not particularly limited, but as shown in FIG. 2, a flat membrane module into which a thin tube is easily inserted, in particular, a spiral-type reverse osmosis membrane module into which a water collection pipe of the permeate water is easily linearly inserted is particularly preferable.

In a case of a spiral reverse osmosis membrane, raw water may be mixed due to deterioration of a sealing material such as an O-ring that seals an outlet on one side of the water collection pipe in rare cases, and the concentration of the divalent ionic substance may become high up to about 30 cm from one sealed end of the water collection pipe. Therefore, when an abnormality is confirmed in the concentration of the divalent ionic substance from the position 30 cm away from the sealed end of the water collection pipe to the other end of the water collection pipe, it can be determined that a problem with the sealing material has occurred.

Of course, also in the second embodiment, it is possible to take out the separation membrane module from the pressure vessel of the actual plant and diagnose the deterioration state of the separation membrane module using the method described above using another evaluation device.

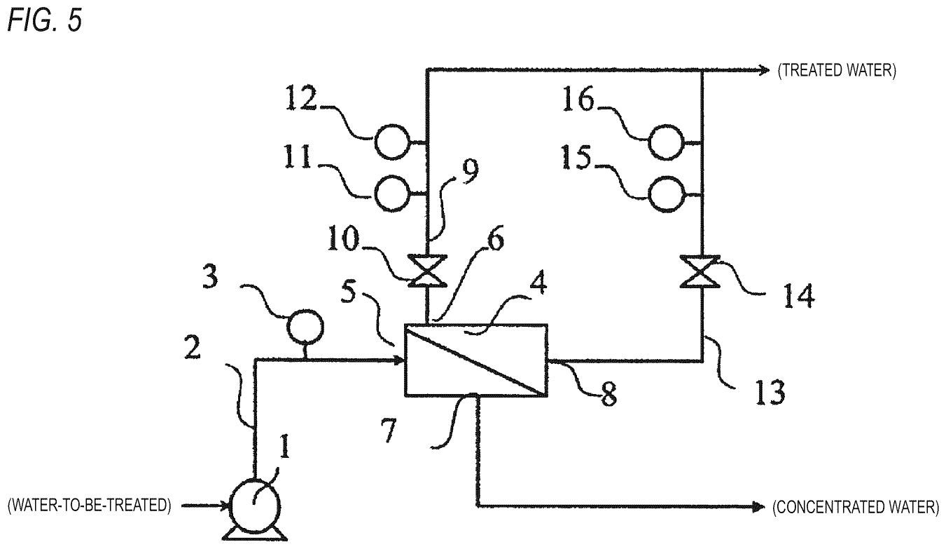

In a case where the separation membrane module has two or more permeate water intake ports as in a third embodiment, in order to further acquire detailed information, a device as shown in FIG. 5 is applied, the separation membrane module has a structure that allows the permeate water to be taken in from at least two positions as in Patent Literature 2 “WO2020-071507: Creation Method for Water Quality Profile, Inspection Method for Separation Membrane Module, and Water Treatment Device”, and the same result as in the second embodiment can be obtained by changing the flow rate ratio of the permeate water.

This method is a very preferable method because, by using an online water quality detector, an operation condition and a concentration index are automatically and continuously acquired, a standard separation performance and a solute permeability coefficient are calculated, and the abnormality diagnosis including the contribution rate of the physical deterioration and the chemical deterioration can be constantly performed. This method is a preferred embodiment since it is possible to detect an abnormality position without inserting a tube into the separation membrane module.

In the case of this method, since there is a possibility that an error occurs when there is a local distribution of an amount of water permeation, a method has also been proposed to improve accuracy by using it in combination with a method of inserting a tube into a water collection pipe as in Japanese Patent Application No. 2021-126114.

A deterioration diagnosis device according to the third embodiment of the present invention (hereinafter, may be simply referred to as the third embodiment) will be described using, as an example, a case in which a spiral-type reverse osmosis membrane element is applied as the separation membrane module, and the test water containing a monovalent ionic substance and a divalent ionic substance is applied as two different types of test water.

A deterioration diagnosis device for a reverse osmosis membrane element according to the third embodiment is a deterioration diagnosis device for a reverse osmosis membrane element including a separation membrane that separates water-to-be-treated containing at least one of first water-to-be-treated containing a monovalent ionic substance and second water-to-be-treated containing a divalent ionic substance into concentrated water and permeate water, and a water collection pipe that collects the permeate water, and cause a computer for diagnosing a deterioration state of the reverse osmosis membrane element to function as a data input unit that inputs, to the computer, an operation condition of the reverse osmosis membrane element during an operation and water quality of first permeate water containing the monovalent ionic substance and water quality of the second permeate water containing the divalent ionic substance, a data recording unit that records, in the computer, the operation condition, the water quality of the first permeate water, and the water quality of the second permeate water, and a deterioration diagnosis calculation unit that diagnoses presence or absence of occurrence of deterioration of the reverse osmosis membrane element based on a predetermined deterioration diagnosis standard of the reverse osmosis membrane element by using a performance of the reverse osmosis membrane element obtained from the operation condition, the water quality of the first permeate water, and the water quality of the second permeate water, and data of a change rate between a concentration of the monovalent ionic substance in the first permeate water and a concentration of the divalent ionic substance in the second permeate water.

In the third embodiment, the computer having the units described above is caused to function to diagnose the deterioration state of the reverse osmosis membrane element. The third embodiment can be recorded in a recording device such as a memory or a hard disk of a computer, and a form of recording is not particularly limited.

The computer includes the data input unit that extracts and inputs the operation conditions of the reverse osmosis membrane element during an operation and data relating to the water quality of the first permeate water and the water quality of the second permeate water for each process, and each measurement value in each process obtained by the data input unit is recorded in the data recording unit.

The presence or absence of occurrence of deterioration of the reverse osmosis membrane element is diagnosed based on the predetermined deterioration diagnosis standard of the reverse osmosis membrane element using data recorded in the data recording unit.

Examples of the data recorded in the data recording unit include data of the performance of the reverse osmosis membrane element obtained from the operation condition, the water quality of the first permeate water, and the water quality of the second permeate water, and the change rate between the concentration of the monovalent ionic substance in the first permeate water and the concentration of the divalent ionic substance in the second permeate water.

According to the third embodiment, the cause of performance deterioration of the reverse osmosis membrane element can be diagnosed extremely easily and quickly.

Specific examples of the water-to-be-treated, the structure of the reverse osmosis membrane element, and the water quality of the first permeate water and the second permeate water in the third embodiment are the same as those in the first embodiment and the second embodiment.

In the third embodiment, the standard for diagnosing whether the main cause of deterioration of the reverse osmosis membrane element is chemical deterioration or physical deterioration is the same as in the first embodiment and the second embodiment. The third embodiment can be recorded on a computer-readable recording medium for use.

### EXAMPLES

The present invention will be specifically described below with reference to Examples, but the present invention is not limited thereto.

### Example 1

Since the water quality deterioration tendency of production water was observed in an ultrapure water production plant, the reverse osmosis membrane element in use was taken out from a vessel, one reverse osmosis membrane element was loaded into a pressure vessel as shown in FIG. 2, and then the separation performance was measured by a performance evaluation device.

Sodium chloride was dissolved in pure water to prepare test water having a concentration of 1500 mg/L, and the test water was operated at a supply pressure of 1.5 MPa, a concentrated water flow rate of 80 L/min, a water temperature of 25° C., and a pH 7 of the water-to-be-treated to obtain permeate water in the pressure vessel. The permeate water 7 was taken out, and the electrical conductivity was measured, and the concentration thereof was obtained from a relationship between sodium chloride and the electrical conductivity.

Thereafter, the test water was changed to pure water, the pure water was supplied to the membrane element loaded into the pressure vessel, after the sodium chloride was washed out, magnesium sulfate was dissolved in the pure water to prepare a solution having a concentration of 2000 mg/L, the solution was operated at a supply pressure of 1.5 MPa, a concentrated water flow rate of 80 L/min, a water temperature of 25° C., and a pH of the water-to-be-treated of 7, by the same method as in the case of sodium chloride, the electrical conductivity of the permeate water containing magnesium sulfate in the water collection pipe was measured, and the concentration thereof was obtained from a relationship between the magnesium sulfate concentration and the electrical conductivity.

As a result, the removal performance of sodium chloride was 98.80% (permeability: 1.20%), and the removal performance of magnesium sulfate was 99.93% (permeability: 0.07%).

The performance of the reverse osmosis membrane element after production measured under the same conditions was 99.74% (permeability: 0.26%) for sodium chloride and 99.97% (permeability: 0.03%) for magnesium sulfate, the separation performance decrease rate was 4.6 times and 2.7 times an initial ratio, respectively, the separation performance decrease rate of magnesium sulfate was not large compared to the separation performance decrease rate of sodium chloride, and therefore sign was confirmed that at least chemical deterioration was the main cause.

As a relationship expression of chemical deterioration, a relationship expression (1) between the analyzed permeability of sodium chloride and the permeability of magnesium sulfate was created based on the separation performance (permeability) of sodium chloride and magnesium sulfate prepared in advance using a membrane obtained by forcibly chemically deteriorating a reverse osmosis membrane by immersing the membrane in hypochlorous acid. In addition, as a relationship expression of physical deterioration, a relationship expression (2) of the permeability of sodium chloride and the permeability of magnesium sulfate, which is obtained on the assumption that the supply water is slightly mixed due to leakage as the scratch becomes larger, was created. When each relationship expressions was plotted, and an initial permeability (before deterioration) and a permeability after the deterioration were further plotted in FIG. 6, the contribution rates of the chemical deterioration and the physical deterioration were calculated to be 97:3, and it was determined that the separation performance was decreased by almost only the chemical deterioration.

### Example 2

The same reverse osmosis membrane element as in Example 1 was evaluated under the same conditions as in Example 1. However, since the water quality deterioration tendency of the production water was observed in the ultrapure water production plant, the reverse osmosis membrane element in use was taken out from the vessel, one reverse osmosis membrane element was loaded into the pressure vessel as shown in FIG. 2, and then the separation performance was measured by the performance evaluation device. However, the tube was passed through from the permeate water pipe of the pressure vessel as shown in FIG. 4, and the permeate water in the water collection pipe of the reverse osmosis membrane element was collected. The electrical conductivity of the permeate water collected at a plurality of positions from the supply water side to the concentrated water side in the water collection pipe was measured, and from a relationship between the sodium chloride concentration, the magnesium sulfate, and the electrical conductivity, the respective concentrations were obtained.

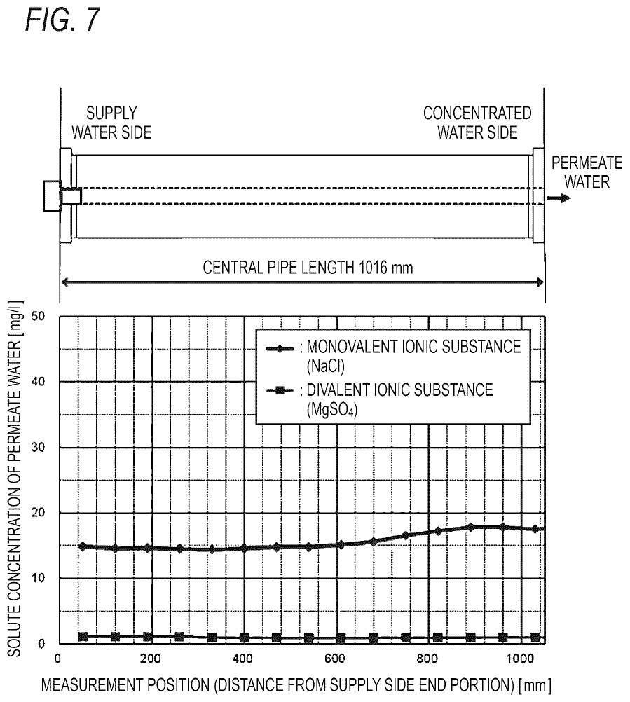

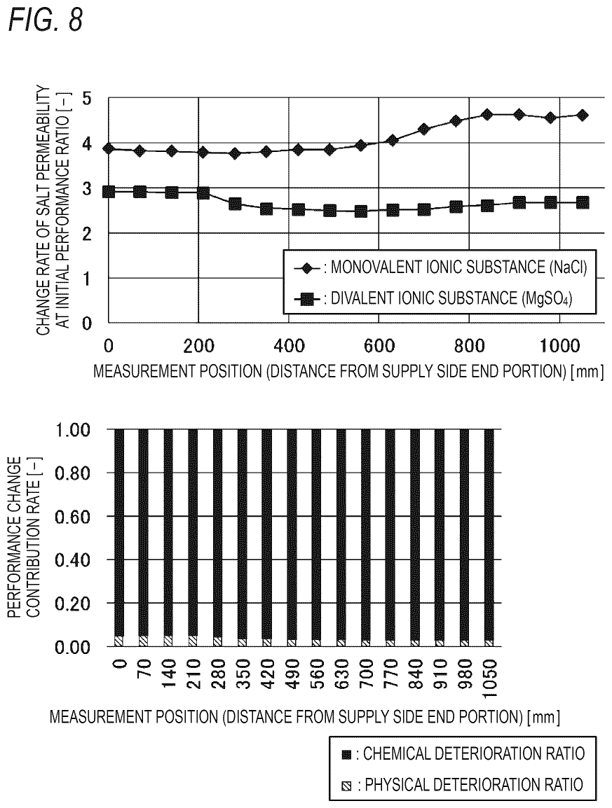

The results are shown in FIG. 7. Based on this result, the separation performance change rate calculated in the length direction in the same manner as in Example 1 and a result of calculating the contribution rate at each position by the same manner as in FIG. 6 are shown in FIG. 8. From these results, it was determined that the separation performance change rates of magnesium sulfate at the head and the rear were small and physical deterioration was slight.

From the above, it was diagnosed that the main cause of deterioration of the reverse osmosis membrane element was chemical deterioration. When the chemical use process of the plant was checked, there was a record in which sodium hypochlorite added in a sterilization process of raw water was added in excess of a predetermined amount, and it was presumed that the sodium hypochlorite leaked to the raw water. Therefore, it was possible to quickly improve operation management of a chemical addition process, to avoid serious trouble of the plant, and to continue water production.

### Example 3

Since the water quality deterioration tendency of production water was observed in a pure water production plant in which hot water sterilization was periodically performed, the reverse osmosis membrane element in use was taken out from the vessel, and one reverse osmosis membrane element was loaded into a reverse osmosis membrane element evaluation device.

The sodium chloride concentration and magnesium sulfate concentration of the permeate water were obtained in the same manner as in Example 1, and as a result, the removal performance of sodium chloride was 98.50% (permeability: 1.50%), and the removal performance of magnesium sulfate was 98.93% (permeability: 1.07%). The performance of the reverse osmosis membrane element after production measured under the same conditions was 99.82% (permeability: 0.18%) for sodium chloride and 99.98% (permeability: 0.02%) for magnesium sulfate, the separation performance decrease rate was 8.4 times and 59.2 times the initial ratio, respectively, the separation performance decrease rate in sodium chloride was as large as 5 times or more, further, the decrease rate in magnesium sulfate was extremely large, and therefore sign was confirmed that at least physical deterioration was the main cause.

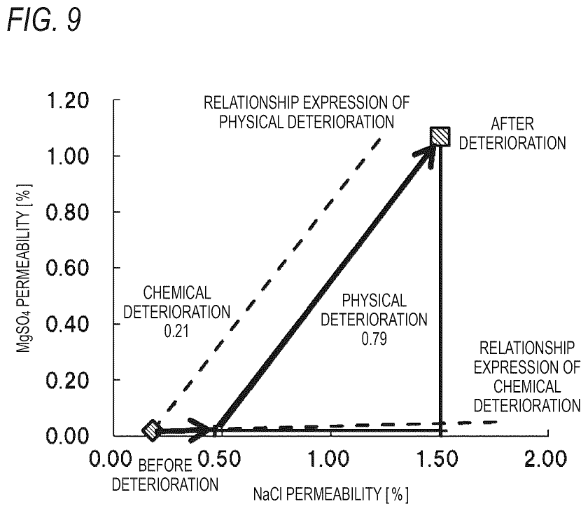

As a relationship expression of chemical deterioration, the relationship expression (1) between the permeability of sodium chloride and the permeability of magnesium sulfate was created based on the separation performance (permeability) of sodium chloride and magnesium sulfate prepared in advance using a membrane obtained by forcibly chemically deteriorating a reverse osmosis membrane by immersing the membrane in hypochlorous acid. In addition, as the relationship expression of physical deterioration, the relationship expression (2) of the permeability of sodium chloride and the permeability of magnesium sulfate, which is obtained on the assumption that the supply water is slightly mixed due to leakage as the scratch becomes larger, was created. When each relationship expression was plotted, and the initial permeability (before deterioration) and the permeability after deterioration were further plotted in FIG. 9, the contribution rates of the chemical deterioration and the physical deterioration were calculated to be 21:79, and it was determined that physical deterioration was the main cause of the separation performance decrease.

### Example 4

The same reverse osmosis membrane element as in Example 3 was evaluated under the same conditions as in Example 2, and permeate water in the water collection pipe of the reverse osmosis membrane element was collected. The electrical conductivity of the permeate water collected at a plurality of positions from the supply water side to the concentrated water side in the water collection pipe was measured, and from a relationship between the sodium chloride concentration, the magnesium sulfate, and the electrical conductivity the respective concentrations were obtained.

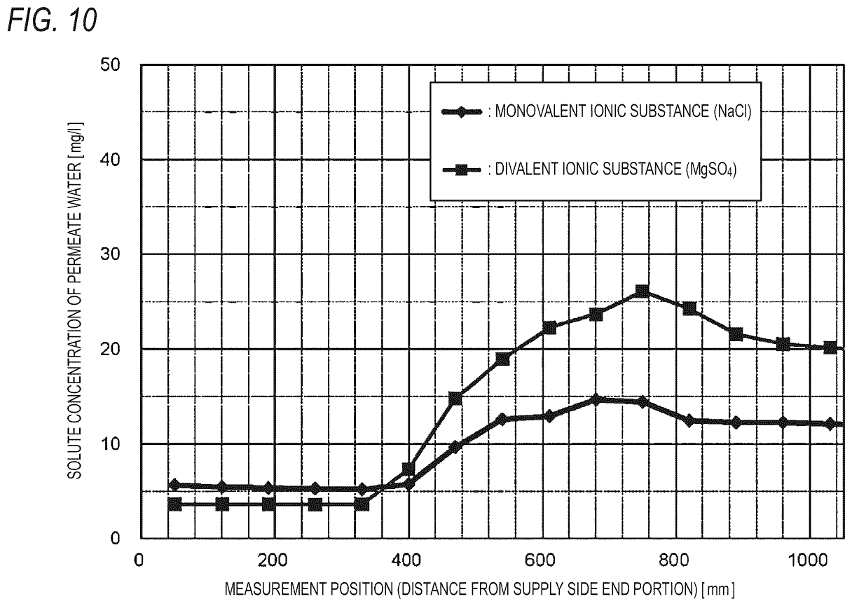

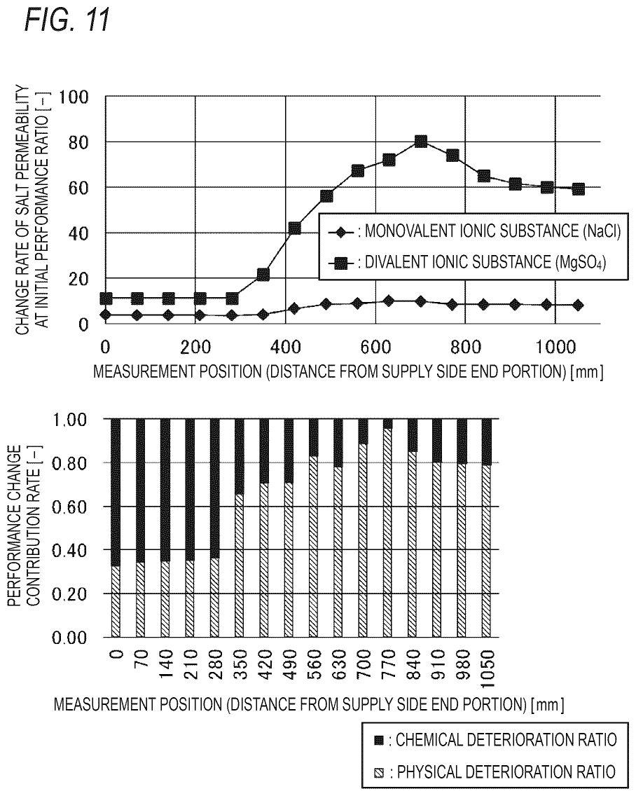

The results are shown in FIG. 10. Based on this result, the separation performance change rate calculated in the length direction in the same manner as in Example 1, and the result of calculating the contribution rate at each position in the same manner as in FIG. 9 are shown in FIG. 11. From these results, it was determined that the separation performance change rates of magnesium sulfate at the head and the rear were large, chemical deterioration occurred, physical deterioration occurred, and in particular, physical deterioration in a central portion of 300 mm to 700 mm was significantly large.

From the above, it was diagnosed that the contribution of physical deterioration is large as a cause of performance deterioration of the reverse osmosis membrane element. When the hot water sterilization process was checked in a plant operation method, it was found that during the cooling of the hot water sterilization process, cooling water was supposed to be introduced at 25° C. after the water temperature in the plant pipe decreased to 35° C., but the cooling water at 25° C. was erroneously introduced at a plant pipe water temperature of 40° C. It was presumed that since rapid cooling was performed from a water temperature of 35° C. or more, wrinkles were generated on the separation membrane surface and physical deterioration occurred. By improving a method of operating the hot water sterilization process quickly and replacing the affected reverse osmosis membrane element, serious troubles in the plant could be avoided and water production could be continued.

### Example 5

In periodic inspection of the ultrapure water production plant, the reverse osmosis membrane element in use was taken out from the vessel, and the sodium chloride concentration and the magnesium sulfate concentration of the permeate water at a plurality of positions in the water collection pipe were obtained in the same manner as in Example 1, and as a result, the removal performance of sodium chloride was 99.37% (permeability: 0.63%), and the removal performance of magnesium sulfate was 99.93% (permeability: 0.07%). The performance of the reverse osmosis membrane element after production measured under the same conditions was 99.80% (permeability: 0.20%) for sodium chloride and 99.98% (permeability: 0.02%) for magnesium sulfate, the separation performance decrease rate was 3.1 times and 3.5 times the initial ratio, respectively, the separation performance decrease rate in magnesium sulfate was not greatly different from the decrease rate in sodium chloride, and therefore sign was confirmed that at least a chemical deterioration was the main cause.

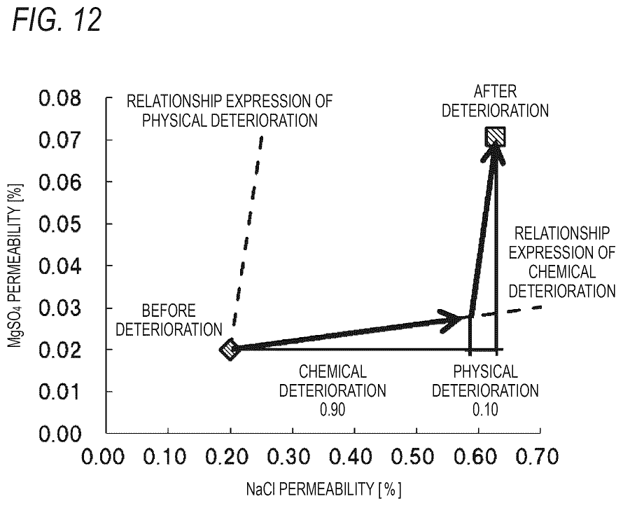

As in Example 1, when the initial permeability (before deterioration) and the permeability after deterioration were plotted in FIG. 12, the contribution rates of the chemical deterioration and the physical deterioration were calculated to be 90:10, and it was determined that the chemical deterioration was the main cause of the separation performance decrease.

### Example 6

The same reverse osmosis membrane element as in Example 5 was evaluated under the same conditions as in Example 2, and permeate water in the water collection pipe of the reverse osmosis membrane element was collected. The electrical conductivity of the permeate water collected at a plurality of positions from the supply water side to the concentrated water side in the water collection pipe was measured, and from the relationship between the sodium chloride concentration, the magnesium sulfate, and the electrical conductivity the respective concentrations were obtained.

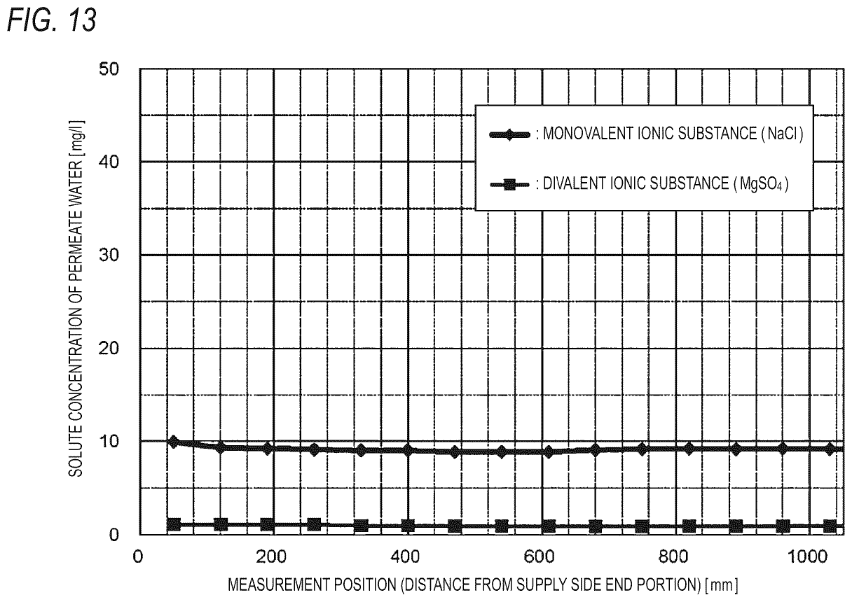

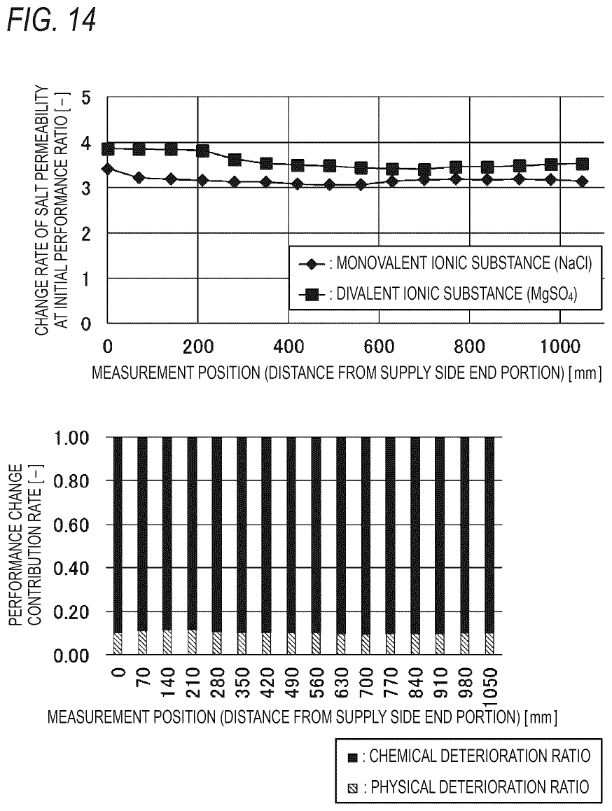

The results are shown in FIG. 13. Based on this result, the separation performance change rate calculated in the length direction in the same manner as in Example 1, and the result of calculating the contribution rate at each position in the same manner as in FIG. 12 are shown in FIG. 14. From these results, it was confirmed that chemical deterioration was the main cause, and that deterioration occurred not locally but entirely.

### Example 7

Since the deterioration in water quality of the production water of the ultrapure water production plant became obvious, the reverse osmosis membrane element in use was taken out from the vessel, and the sodium chloride concentration and the magnesium sulfate concentration of the permeate water at a plurality of positions in the water collection pipe were obtained by the same method as in Example 1, and as a result, the removal performance of sodium chloride was 88.24% (permeability: 11.76%), and the removal performance of magnesium sulfate was 95.95% (permeability: 4.05%). The performance of the reverse osmosis membrane element after production measured under the same conditions was 99.82% (permeability: 0.18%) for sodium chloride and 99.98% (permeability: 0.02%) for magnesium sulfate, the separation performance decrease rate was 65.3 times the initial ratio and 225.2 times the initial ratio, respectively, both the separation performance decrease rate of sodium chloride and the separation performance decrease rate of magnesium sulfate were large, and therefore it was difficult to determine the main cause.

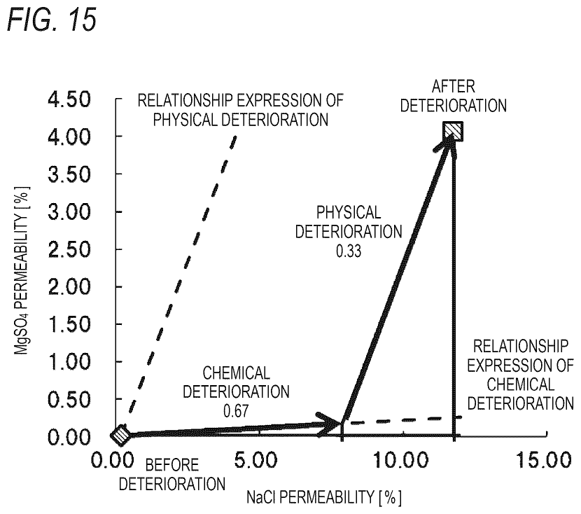

Here, as in Example 1, when the initial permeability (before deterioration) and the permeability after deterioration were plotted in FIG. 15, the contribution rates of the chemical deterioration and the physical deterioration were calculated to be 67:33, and it was determined that both the chemical deterioration and the physical deterioration were factors and the contribution of the chemical deterioration was slightly larger in separation performance decrease.

### Example 8

The same reverse osmosis membrane element as in Example 7 was evaluated under the same conditions as in Example 2, and permeate water in the water collection pipe of the reverse osmosis membrane element was collected. The electrical conductivity of the permeate water collected at a plurality of positions from the supply water side to the concentrated water side in the water collection pipe was measured, and from the relationship between the sodium chloride concentration, the magnesium sulfate, and the electrical conductivity the respective concentrations were obtained.

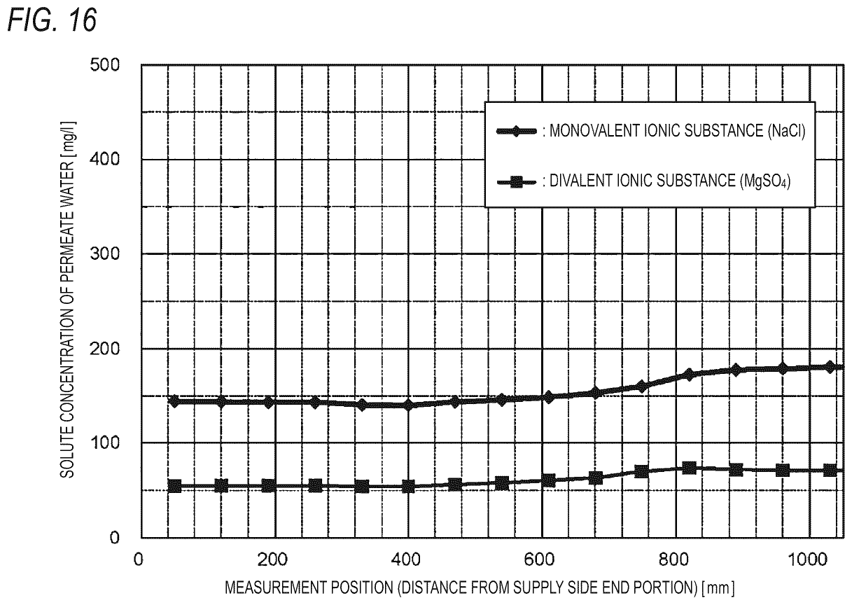

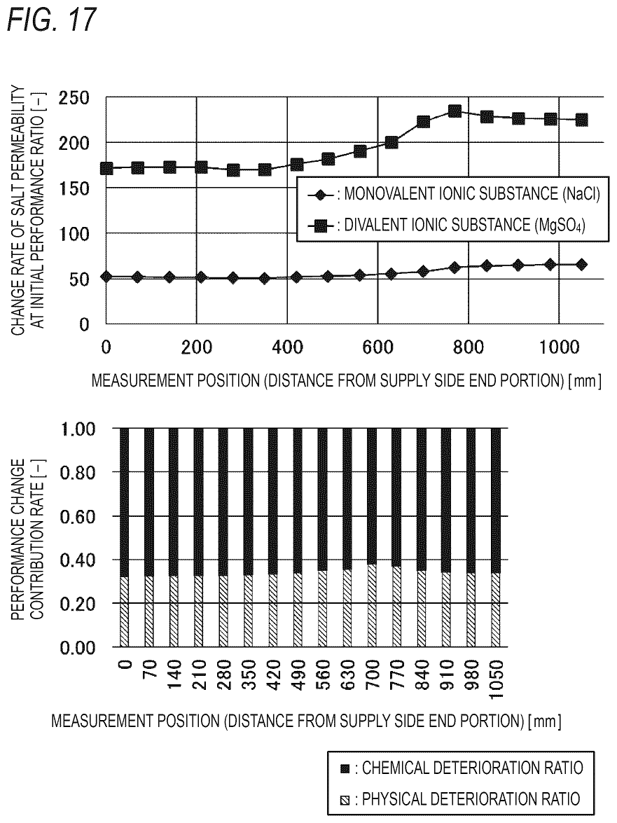

The results are shown in FIG. 16. Based on this result, the separation performance change rate calculated in the length direction in the same manner as in Example 1, and the result of calculating the contribution rate at each position in the same manner as in FIG. 15 are shown in FIG. 17. From these results, it was determined that the separation performance change rate of magnesium sulfate at the rear was larger than at the head, and physical deterioration and chemical deterioration occurred relatively uniformly, although the contribution of physical deterioration at the rear position was somewhat large.

Later date, when the reverse osmosis membrane element was disassembled to confirm the cause of deterioration, and the membrane surface was observed, crystalline deposits were present on the entire surface of the membrane, and from the result of dyeing the membrane, it was assumed that the precipitated crystalline salt caused scratches on the entire surface of the membrane.

### Comparative Example 1

As shown in Example 1, since the water quality deterioration tendency of the production water was observed in the ultrapure water production plant, the reverse osmosis membrane element in use was taken out from the vessel, one reverse osmosis membrane element was loaded into the pressure vessel as shown in FIG. 2, and then the separation performance was measured by the performance evaluation device.

Sodium chloride was dissolved in pure water to prepare test water having a concentration of 1500 mg/L, and the test water was operated at a supply pressure of 1.5 MPa, a concentrated water flow rate of 80 L/min, a water temperature of 25° C., and a pH 7 of the water-to-be-treated to obtain permeate water in the pressure vessel. The permeate water 7 was taken out, and the electrical conductivity was measured, and the concentration was obtained from a relationship between sodium chloride and the electrical conductivity. As a result, the removal performance of sodium chloride was 98.80% (permeability: 1.20%). The sodium chloride removal rate after production of the reverse osmosis membrane element measured under the same conditions was 99.74% (permeability: 0.26%), and the separation performance was decreased by 4.6 times, but it was unclear whether it was chemical deterioration or physical deterioration, and no countermeasure guidelines could be established.

The reverse osmosis membrane element was disassembled taking time and effort, and the disassembled membrane was dyed, but there were no noticeable scratches on the membrane surface, and it could not be considered that the main cause of deterioration was physical deterioration. Further, when the reverse osmosis membrane piece was immersed in a solution in which an alkali aqueous solution and pyridine were mixed, coloration was observed, it was confirmed that oxidative deterioration occurred, and it was concluded that the main cause of deterioration was chemical deterioration. However, the ratio of chemical deterioration to physical deterioration could not be estimated.

### Comparative Example 2

As shown in Example 3, since the water quality deterioration tendency of production water was observed in the pure water production plant in which hot water sterilization was periodically performed, the reverse osmosis membrane element in use was taken out from the vessel, and one reverse osmosis membrane element was loaded into the reverse osmosis membrane element evaluation device.

The removal performance of sodium chloride was measured in the same manner as in Comparative Example 1, and as a result, the removal performance of sodium chloride was 98.50% (permeability: 1.50%), and the removal performance of magnesium sulfate was 98.93% (permeability: 1.07%). The sodium chloride removal rate after production of the reverse osmosis membrane element measured under the same conditions was 99.82% (permeability: 0.18%), and the separation performance was decreased by 8.4 times, but it was unclear whether it was chemical deterioration or physical deterioration, and no countermeasure guidelines could be established.

When the reverse osmosis membrane element was disassembled taking time and effort, wrinkles on the membrane surface were confirmed, and when the disassembled membrane was dyed, since many scratches were confirmed on the membrane surface, it was confirmed that major physical deterioration had occurred, and it was impossible to determine whether the chemical deterioration had occurred. Further, when the reverse osmosis membrane piece was immersed in a solution in which an alkali aqueous solution and pyridine were mixed, coloration was observed, it was confirmed that oxidative deterioration occurred, and it was concluded that the performance decrease was due to both chemical deterioration and physical deterioration. However, the ratio of chemical deterioration to physical deterioration ratio could not be estimated.

### Comparative Example 3

As shown in Example 5, in the periodic inspection of the ultrapure water production plant, the reverse osmosis membrane element in use was taken out from the vessel, and one reverse osmosis membrane element was loaded into the reverse osmosis membrane element evaluation device.

The removal performance of sodium chloride was measured in the same manner as in Comparative Example 1, and as a result, the removal performance of sodium chloride was 98.50% (permeability: 1.50%). The sodium chloride removal rate after production of the reverse osmosis membrane element measured under the same conditions was 99.82% (permeability: 0.18%), and the separation performance was decreased by 3.1 times, but it was unclear whether it was chemical deterioration or physical deterioration, and no countermeasure guidelines could be established.

When the reverse osmosis membrane element was disassembled taking time and effort, there was no abnormality in appearance, there was almost no scratch on the membrane surface after dyeing, a sign of occurrence of physical deterioration was not confirmed, and therefore it was assumed that chemical deterioration was the main cause, but the cause could not be determined through surface observation. Further, when the reverse osmosis membrane piece was immersed in a solution in which an alkali aqueous solution and pyridine were mixed, coloration was observed, it was confirmed that oxidative deterioration occurred, and it was concluded that the main cause of deterioration was chemical deterioration. However, the ratio of chemical deterioration to physical deterioration could not be estimated.

### Comparative Example 4

Since the deterioration in water quality of the production water of the ultrapure water production plant became obvious, the reverse osmosis membrane element in use was taken out from the vessel, and one reverse osmosis membrane element was loaded into the reverse osmosis membrane element evaluation device.

In the same method as in Example 1, the sodium chloride concentration of permeate water at a plurality of positions in the water collection pipe was obtained, and as a result, the removal performance of sodium chloride was 88.24% (permeability: 11.76%). As for the performance after production of this reverse osmosis membrane element measured under the same conditions, sodium chloride was 99.82% (permeability: 0.18%), and it was found that the separation performance was decreased to 65.3 times, but it was unclear whether it was chemical deterioration or physical deterioration, and no countermeasure guidelines could be provided.

When the reverse osmosis membrane element was disassembled taking time and effort, and the membrane surface was observed, crystalline deposits were present on the entire membrane surface and it was assumed that a large amount of scratches were generated on the entire membrane surface due to the precipitated crystalline salt from the result of dyeing the membrane. However, the presence or absence of chemical deterioration could not be determined from this result. Further, when the reverse osmosis membrane piece was immersed in a solution in which an alkali aqueous solution and pyridine were mixed, no coloration was observed, and occurrence of oxidative deterioration could not be detected.

Although various embodiments have been described above with reference to the drawings, the present invention is not limited to these examples. It is apparent to those skilled in the art that various changes or modifications can be conceived within the scope described in the claims, and it should be naturally understood that those belong to the technical scope of the present invention. In addition, the configuration components described in the above embodiments may be combined optionally without departing from the gist of the invention.

The present application is based on a Japanese patent application (Japanese Patent Application No. 2021-213457) filed on Dec. 27, 2021, and the contents thereof are incorporated herein by reference.

### REFERENCE SIGNS LIST

1: reverse osmosis membrane

2: permeate water channel member

3: water-to-be-treated channel member (net spacer)

4: water collection pipe

5: telescope prevention plate

6, 6′: water-to-be-treated

7, 7′: permeate water

8: concentrated water

9: pressure vessel

10: tube

11: electrical conductivity meter

21: hollow fiber membrane

22: potting

23: filtrate-water side cap

24: backwash water discharge port

25: supply water discharge port

26: filtrate-water outlet nozzle

27: supply water inlet nozzle

28: supply water inlet

1. A state diagnosis method for a separation membrane module for obtaining permeate water from water-to-be-treated, the state diagnosis method comprising:
supplying a test water containing at least two types of solutes to a separation membrane module, or individually supplying at least two types of a test water containing at least one type of solute to the separation membrane module; and
comparing a separation performance based on a concentration of the solute contained in the permeate water to determine any of a type of an abnormality, a degree of an abnormality, and a generation position of an abnormality of the separation membrane module.

2. The state diagnosis method for a separation membrane module according to claim 1, wherein the at least two types of solutes are ionic substances having different valences or substances having different molecular weights.

3. The state diagnosis method for a separation membrane module according to claim 1, wherein the comparison of the separation performance is performed based on a concentration index of the permeate water, a concentration converted from the concentration index, a standard separation performance converted based on an operation condition, and a solute permeability coefficient calculated based on an operation data.

4. The state diagnosis method for a separation membrane module according to claim 2, wherein the ionic substances having different valences are at least a substance comprising a monovalent cation and a substance comprising a divalent cation.

5. The state diagnosis method for a separation membrane module according to claim 2, wherein the ionic substances having different valences are at least a substance comprising a monovalent anion and a substance comprising a divalent anion.

6. The state diagnosis method for a separation membrane module according to claim 1, wherein the at least two types of the test water have a same solute and is changed in pH or temperature.

7. The diagnosis method for a separation membrane module according to claim 3, wherein
the concentration index of the permeate water is any of an electrical conductivity, TOC, a refractive index, a turbidity, an absorbance, an emission intensity, a chromaticity, IR, a mass spectrometry, an ion chromatography, ICP, pH, and a radiation ray.

8. The state diagnosis method for a separation membrane module according to claim 1, wherein the permeate water is taken in from at least two positions of a module, and the separation performances are compared.

9. The state diagnosis method for a separation membrane module according to claim 8, wherein a method of taking in the permeate water from the at least two positions is a method of passing a thin tube to the separation membrane module and collecting the permeate water at different positions of the separation membrane module to measure a water quality.

10. The state diagnosis method for a separation membrane module according to claim 9, wherein the separation membrane module is a spiral-type reverse osmosis membrane module, and taking in the permeate water is performed by inserting the tube into a central pipe for permeate water collection and moving the tube.

11. The state diagnosis method for a separation membrane module according to claim 8, wherein the separation membrane module has a structure that allows the permeate water to be taken in from at least two positions, and a flow rate ratio of the permeate water is changed.

12. The state diagnosis method for a separation membrane module according to claim 1, wherein the separation performance for the test water in a state before use of the separation membrane module is measured or predicted in advance, and a state of the separation membrane module is determined based on a deviation from a value thereof.

13. The state diagnosis method for a separation membrane module according to claim 12, wherein a chemical deterioration profile in which the separation performance deteriorates by bringing the separation membrane module into contact with a chemical and a physical deterioration profile in which the separation performance decreases by causing a physical scratch on a supply side of the separation membrane module are prepared in advance, and contribution of a chemical deterioration and a physical deterioration is determined by comparing the prepared profiles with a measured separation performance of the separation membrane module.

14. The state diagnosis method for a separation membrane module according to claim 1, wherein in the comparison of the separation performance of the at least two types of solutes, when a separation performance decrease rate of the solute having a higher separation performance is twice or more as large as a separation performance decrease rate of the solute having a lower separation performance, it is determined that the physical deterioration occurs.

15. A state diagnosis device for a separation membrane module, the state diagnostic device comprising:
at least two types of detectors configured to supply a test water containing at least two types of solutes to a separation membrane module and periodically detect a concentration of each of the solutes contained in permeate water;
a separation performance comparing unit configured to compare separation performances based thereon; and
an abnormality determining unit configured to automatically determine any of a type of an abnormality, a degree of an abnormality, and a generation position of an abnormality of the separation membrane module by the separation performance comparing unit.

16. The state diagnosis device for a separation membrane module according to claim 15, wherein
the detector is an online detector in which any of an electrical conductivity, a UV absorption, TOC, a refractive index, a turbidity, an absorbance, a fluorescence intensity, a chromaticity, and PH is detected, and
the state diagnosis device comprises a calculation unit configured to automatically calculate a degree of performance decrease of the separation membrane module and a contribution rate of a physical deterioration and a contribution rate of a chemical deterioration based on any of a concentration index automatically based on a detection value, a concentration converted from the concentration index, a standard separation performance converted based on an operation condition, and a solute permeability coefficient calculated based on an operation data.

17. The state diagnosis device for a separation membrane module according to claim 15, wherein the separation performance of the separation membrane module obtained by adding the two types of solutes to water-to-be-treated in a pulsed manner and measuring a change in permeate water quality is compared and automatically make determination.

18. The calculation unit for state diagnosis of the separation membrane module according to claim 15 and a computer-readable recording medium recording the calculation unit.
